(19) United States
(12) Patent Application Publication
(10) Pub. No.: US 2018/0026577 A1
(43) Pub. Date: Jan. 25, 2018

(54) DEVICE FOR ATTACHING A SOLAR PANEL

(71) Applicant: CIEL ET TERRE INTERNATIONAL, Sainghin en Melantois (FR)

(72) Inventors: Alexis GAVEAU, Hellemmes (FR); Florian GOFFART, Hellemmes (FR)

(21) Appl. No.: 15/546,107

(22) PCT Filed: Feb. 3, 2016
(86) PCT No.: PCT/FR2016/050227

§ 371 Date: Jul. 25, 2017

(30) Foreign Application Priority Data
Feb. 4, 2015 (FR) 15 50855

(51) Int. Cl. H02S 30/10; H02S 20/23; B63B 35/44; F16B 2/04; F16B 2/12; F24J 2/52; H02S 10/40

(52) U.S. Cl. CPC H02S 30/10; F24J 2/5254; F24J 2/5256; F24J 2/5264; F24J 2/5267; H02S 20/23; H02S 10/40; F16B 2/04; F16B 2/12; B63B 35/44; F24J 2002/4661

(57) ABSTRACT

Disclosed is a device for attaching a solar panel including at least two retaining elements, suitable for retaining a panel by engaging with two opposing parts of the solar panel, at least one of the retaining elements being movable in a direction defined by a guide system and in such a way as to allow an adjustment of the spacing between the two retaining elements. The device includes: an assembly including a fixed support and the mobile retaining element, the mobile retaining element and the fixed support consisting respectively of two synthetic parts, in particular two plastic parts, the guide system being produced by mutually engaging structures between the mobile retaining element and the fixed support produced as a one-piece component with the parts forming the fixed support and the mobile retaining element.

The invention relates to a device for attaching a solar panel, in particular framed, able to retain a solar panel on two of its edges.

The field of the invention is that of the installation and the attaching of photovoltaic panels, in particular on a frame, such as for example on a roof, or for example, on a floating system of a floating solar power station.

A solar panel, very often, is provided with an aluminium frame and it is known to attach the panel thanks to a system of clamps, machined metal parts, each engaging with a flange of the frame of the panel. The clamping of the frame is obtained by the clamping of the bits of the clamp, conventionally by screwing.

In order to be able to take into account different dimensions of photovoltaic panels, it is moreover known to provide a rail along which two of the clamps can be displaced, then be fixed in adjustable positions in order to retain two edges of the frame of the panel.

Such a technique for attaching is, for example, disclosed by document DE 10 2009 019 548 A1 which teaches a support module which has a particular an application for the installation of a solar panel on a roof with a horizontal surface. This module comprises a thermoformed plastic shell provided on the upper portion thereof with a system of clamps with adjustable positions. This system comprises a rail, extending over the entire width of the panel and of the module, and inside of which two clamps can be displaced. The blocking of the clamps in fixed positions in the rail is obtained by tightening a locking screw. Each one of the clamps is able to engage with the aluminium frame of a panel, with the tightening also being obtained by screwing.

According to the findings of the inventor, such a system for attaching has the advantage of being able to attach the solar panel by engaging with two of the opposite edges of the frame, and in an adjustable way, which makes it possible to take different dimensions between panels into account.

However and according to the findings of the inventor, the system for attaching with clamps with adjustable positions of document DE 10 2009 019 548 A1 has the following disadvantages:

a substantial cost price due to the metal parts, of which most are machined, in order to produce the clamps, and the rails, as well as the screw locking members in particular,

a relatively long installation in that it requires tightening the first screws in order to provide the adjustment of the positions of the clamps, according to the dimension of the panel, then the tightening of the second screws, in order to clamp the edges of the solar panel.

Moreover, according to the findings of the inventors, the first screws for locking in position of the clamps in the rail, as well as the second screws for tightening the clamps are, during the installation of the panel, located underneath the latter, and therefore difficult to access for the tools, which further complicates installation. The clamps themselves are located under the panel, during the installation, which obliges the operator to manipulate these clamps along rails, in an uncomfortable position, directly under the panel.

According to the findings of the Applicant, another problem that can be encountered is that of the expansion of the solar panel and that of its attaching support. Such expansions, when they are heterogeneous, can be at the origin of tensions in the solar panel.

For example, such problems have been encountered for panel support floaters such as taught by document WO 2012/139998A2 of which the plastic casing can expand differently from that of the panel. The attaching of the solar panel by two opposing parts of the panel is carried out during the mounting, without generating any particular stress. However, according to the variations in climatic conditions, (temperature of the atmosphere, sunshine, temperature of the water) the expansions of the casing of the floater and/or of the panel can generate internal tensions in the solar panel which can deteriorate it.

The purpose of this invention is to overcome all or a portion of the aforementioned disadvantages by proposing a device for attaching a panel securely, able to retain a panel by two of the opposite edges of the frame, in an adjustable manner, and with an optimised cost price.

Another purpose of this invention is to propose such a device for attaching that greatly facilitates installation, in particular the manoeuvring of the mobile elements of the system, their adjustment into position, then the locking thereof.

Another purpose of this invention is to propose, at least according to an embodiment, an assembly comprising a solar panel and a device for attaching retaining the panel by two opposing parts of the panel, and which does not generate any stress on the solar panel, even when the solar panel and the attaching support thereof expand differently.

Other purposes and advantages of this invention shall appear in the description which is provided solely for the purposes of information and which does not have the purpose of limiting it.

The invention relates to a device for attaching a solar panel comprising at least two retaining elements, suitable for retaining a panel by engaging with two opposing parts of the solar panel, at least one of the retaining elements being movable in a direction defined by a guide system and in such a way as to allow an adjustment of the spacing between the two retaining elements.

According to the invention, the device has an assembly comprising a fixed support and said mobile retaining element, said mobile retaining element, and said fixed support consisting respectively of two synthetic parts, in particular plastic parts, the guide system being produced by mutually engaging structures between said mobile retaining element, and said fixed support produced as a one-piece component with said parts forming said fixed support and said mobile retaining element.

According to optional characteristics of the invention, taken alone or in combination:

said assembly has said mobile retaining element which comprises a hook intended engage with the frame of the solar panel, said hook being a one-piece component with said part forming said mobile retaining element;

the hook is turned outwards and in such a way as to engage with a lower flange of the frame, when the two retaining elements engaging with the two opposing parts of the solar panel are separated from one another;

the device comprises an abutment system, removably attached on said retaining element, able to prohibit the withdrawal of the lower flange of the frame of the solar panel, by the creation of an abutment, with the frame of the panel engaged, imprisoned between the hook, internal to the frame of the solar panel, and the abutment system external to said frame of the solar panel;

the abutment system comprises a plastic element, and means of reversible snap-fitting distributed between said plastic element and said retaining element;

the abutment system comprises, said plastic element, as well as a screw, engaging in the screwing with the plastic element, with the screwing of the screw authorising the suppression of the mounting play of the frame taken, on the one hand, interiorly by the hook engaging with the lower flange of the frame, and the abutment system of which the screw bears without play outside of the frame of the solar panel;

the hook has a converging inner structure and is arranged in such a way as to provoke a clamping of the flange of the frame when the hook of the mobile retaining element is displaced in the direction of the flange of the frame;

the mutually engaging structures of said guide system between said retaining element and said fixed support form a sliding connection between the two synthetic parts; for example the mutually engaging structures forming the sliding connection of said guide system comprise a protruding portion under the body of the part forming said retaining element, and a complementary groove along the part forming said fixed support;

According to an alternative embodiment of said guide system:

the guide system comprises a longitudinal opening passing through the body of the fixed support, oriented in the adjusting direction, as well as a protruding portion of the body of the mobile retaining element, passing through said longitudinal opening and guided by said longitudinal opening, and preferably said protruding portion is terminated by an enlarged end, intended to engage in abutment with the underside of the body of said fixed support.

According to an embodiment, said enlarged end is oriented, lengthwise, substantially orthogonally to the axis of said protruding portion, with a width less than the width of the longitudinal opening of said fixed support, at least locally on the longitudinal opening, and with a length that is greater than the width of said longitudinal opening, and in such a way as to allow for the assembly of the fixed support with said mobile retaining element by the following steps:

insertion of the enlarged end of the mobile retaining element, oriented along the axis of the longitudinal opening, through the longitudinal opening of the support element,

rotation of the mobile retaining element with respect to the fixed support along the axis of the protruding portion, in particular a quarter turn, and in such a way as to provide the assembly of the two parts.

According to optional characteristics of the invention, taken alone or in combination:

the device has a system for locking the position of the mobile retaining element with respect to said fixed support, in several discrete adjusting positions, said system for locking comprising at least partially structures of said mobile retaining element and of said fixed support, distributed in the direction D of said guide system, produced as a one-piece component with said parts forming said fixed support and said mobile retaining element;

the structures of said system for locking comprise a plurality of adjusting openings of said fixed support, distributed, more preferably regularly spaced, along the adjusting direction, as well as at least one corresponding opening of said mobile retaining element intended to be placed facing one of the openings of said fixed support that is most suited for adjusting, a locking member, such as a pin being intended to pass through said facing openings in order to provide the locking of the position;

the device has a snap-fitting system that is preferably reversible, configured to ensure the retaining of the locking member in the opening of said retaining element: the mutually engaging parts of the snap-fitting system are distributed between the part of the retaining element and the locking member.

said locking member is comprised as a scored portion of the part forming the body with said mobile retaining element or part forming said fixed support;

the structures of said system for locking comprise toothings between said mobile retaining element and said fixed support, with an anti-reverse function, and engaging mutually in such a way as to authorise a displacement according to a first direction, in the adjusting direction, between said mobile retaining element and said fixed support, with the toothing prohibiting the reverse direction of displacement.

said mobile retaining element comprises an engagement portion such as said hook intended to engage with the frame of the solar panel when the two retaining elements are separated, as well as a protruding portion of said engagement portion in the form of a pull tab, for the grasping, or equivalent intended to extend substantially parallel to the solar panel, outwards of said solar panel, and in such a way as to exit outwards;

said fixed support comprises a fitting groove, located underneath the body of said fixed support, open downwards, oriented lengthwise according to a direction orthogonal to the adjusting direction and able to allow for the attaching of said fixed support, to a complementary rib intended to be threaded into said fitting groove;

the device is provided with a blocking member, intended to be inserted, through an upper opening of said fixed support, once the rib threaded into the fitting groove, and in such a way as to form a physical abutment for an end of the attaching rib and prohibit the withdrawal thereof;

the blocking member is a plastic part, with the retaining of the blocking member (in the opening of said fixed support) being provided thanks to means of snap-fitting distributed between said blocking member and said fixed support;

the device for attaching has two independent assemblies, each comprising a fixed support and said mobile retaining element, the mobile retaining elements of two assemblies being intended to engage with two opposing parts of said solar panel, in particular two parallel flanges of the frame of the solar panel;

said part forming said mobile retaining element, as well as said part forming said fixed support are injection-moulded plastic parts,

the plastic part forming said mobile retaining element and/or the plastic part forming said fixed support have a reinforcing rib.

The invention further relates to a method for manufacturing a device for attaching in accordance with the invention, wherein said mobile retaining element, as well as said fixed support, are obtained, respectively, by injection moulding of a synthetic material, with the structures of the guide system, where applicable the structures of the system for locking being obtained during the moulding of the two plastic parts.

The invention further relates to an assembly comprising a solar panel retained by a device for attaching a solar panel according to the invention comprising at least two retaining elements, retaining said panel by engaging with two opposing parts of the solar panel, at least one of the retaining elements being movable in a direction defined by a guide system and in such a way as to allow an adjustment of the spacing between the two retaining elements with said assembly comprising said fixed support and said mobile retaining element, said mobile retaining element, and said fixed support consisting respectively of two synthetic parts, the guide system being produced by mutually engaging structures between said mobile retaining element and said fixed support produced as a one-piece component with said parts forming said fixed support and said mobile retaining element.

According to an advantageous embodiment at least one of the two retaining elements provides the retaining of said solar panel, at one of the two opposing parts of the solar panel, in a fixed position with respect to the support whereon are fixed the two retaining elements and their fixed support, while the other retaining element providing the retaining by engaging with the other opposing part of the panel, is left mobile with respect to said corresponding fixed support, in the direction and in such a way as to authorise the sliding of said mobile retaining element along said corresponding fixed support, in particular in the case of heterogeneous expansions between the solar panel and the support.

According to an embodiment, the support providing an inclination of the solar panel in relation to the horizontal, for example by an angle a between 10° and 30°, said retaining element retaining the part of the solar panel, in the upper portion of the solar panel is that of the device in accordance with the embodiment of which the hook is turned outwards and in such a way as to engage with a lower flange of the frame of the solar panel, with the force of gravity on the solar panel naturally retaining the flange engaged with the hook of said retaining element, while said retaining element left mobile in the direction is located in the lower portion of the solar panel.

The invention shall be better understood when reading the following description accompanied with annexed figures among which:

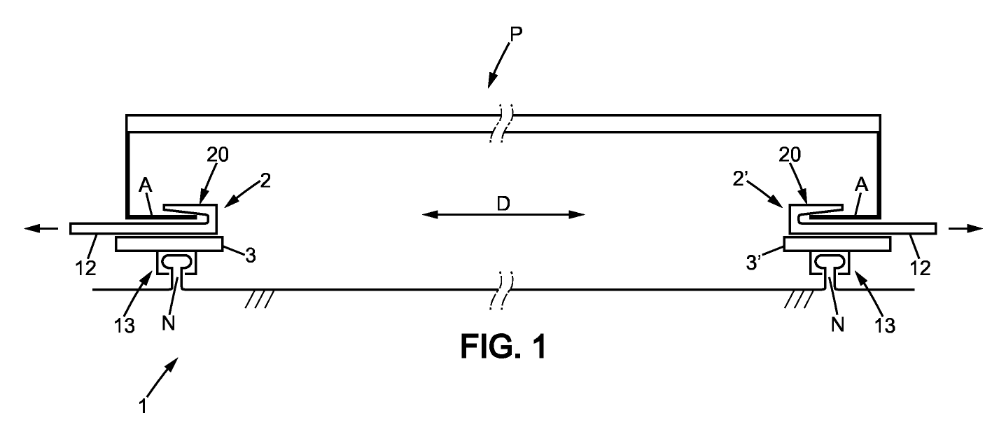

FIG. 1 is a diagrammatical view of a device for attaching, according to an embodiment, comprising two mobile retaining elements providing the attaching of the solar panel via its frame from the inside,

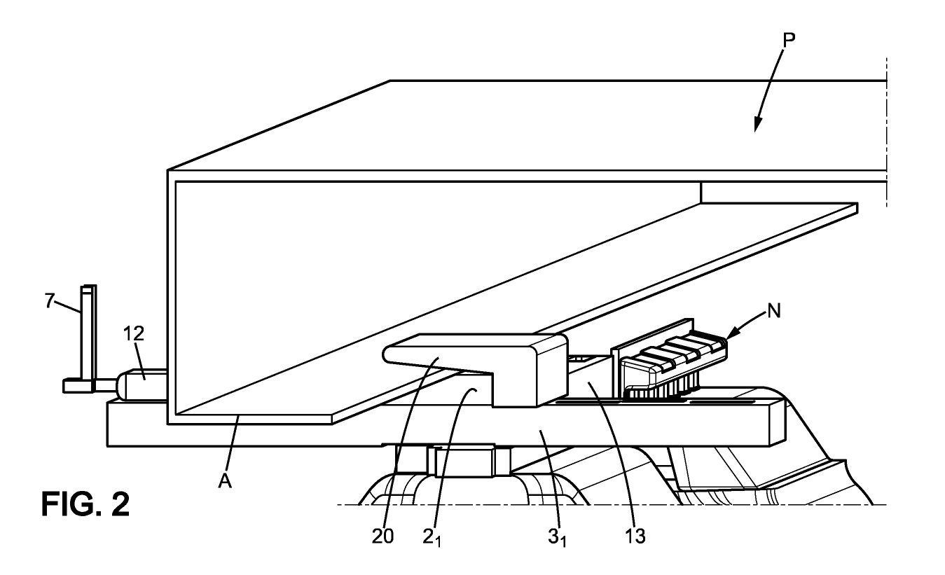

FIG. 2 is detailed perspective view of the attaching of the panel, at the level of an edge of the frame, according to an embodiment of the device,

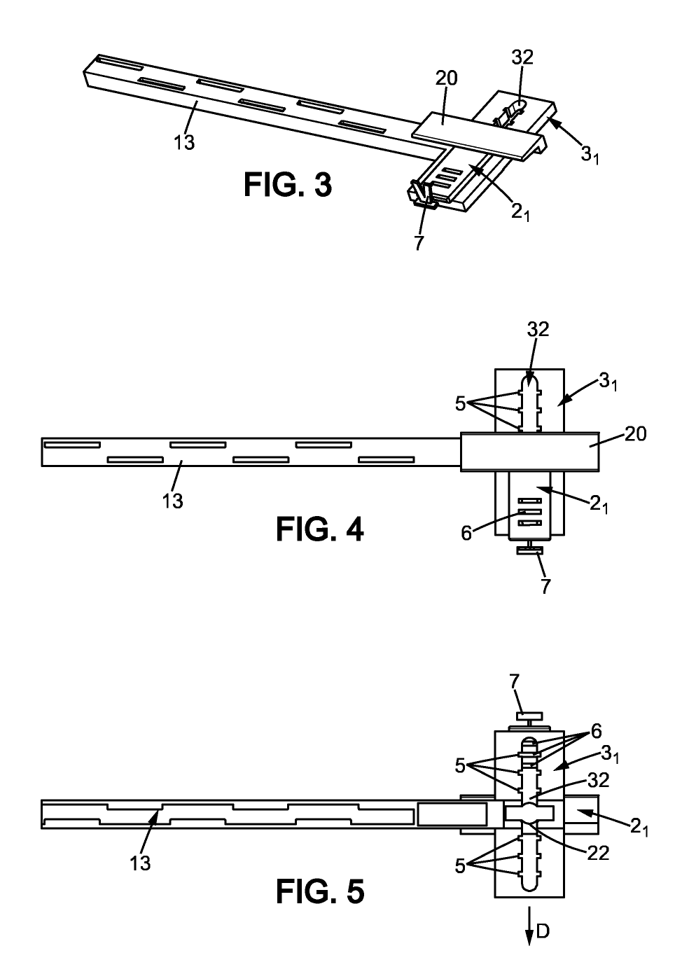

FIGS. 3, 4 and 5 are respectively perspective views, of the top and of the bottom of a device for attaching in accordance with the invention, according to a first embodiment,

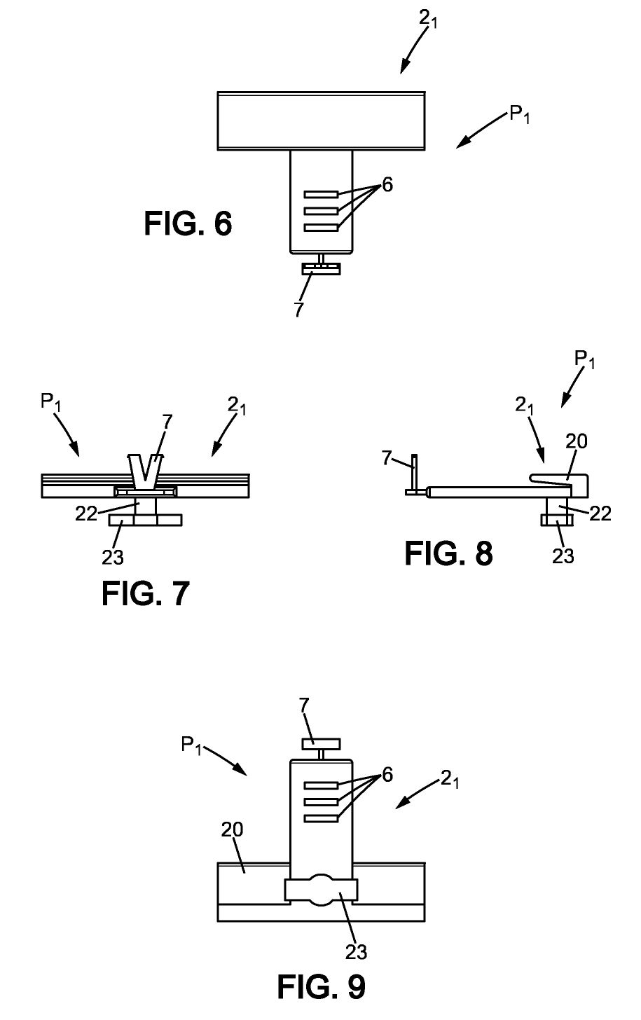

FIGS. 6, 7, 8 and 9 are respectively top, front, side and bottom views of the mobile retaining element of the device for attaching shown in FIGS. 3 to 5,

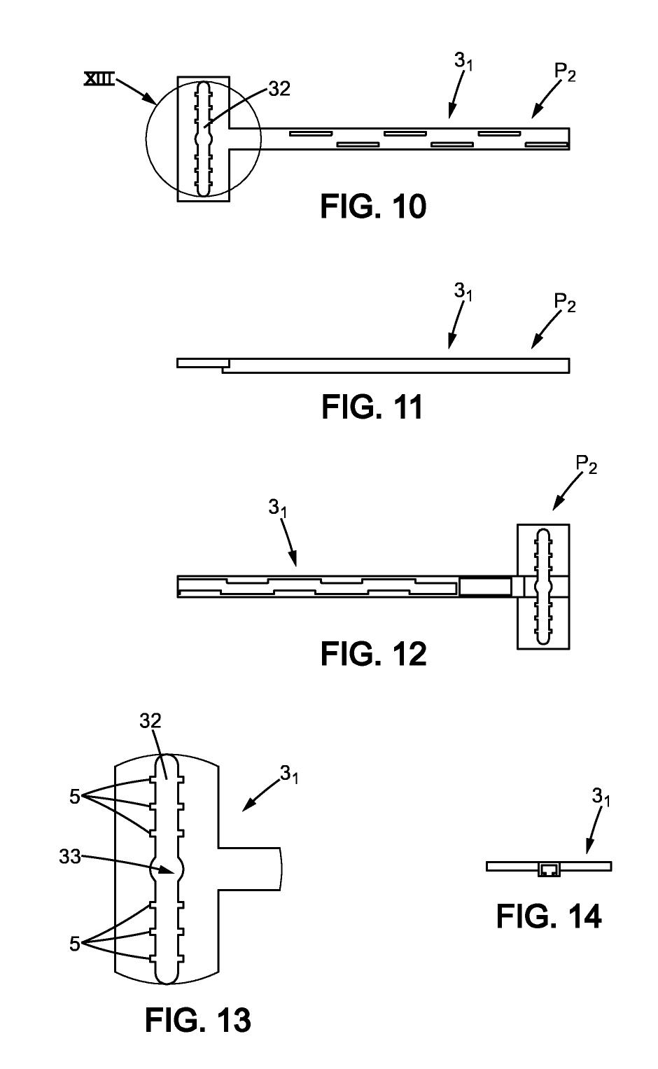

FIGS. 10, 11, 12, 13 and 14 are respectively top, side, bottom detailed (according to the frame XI-XI), and front views, of the fixed support of the device for attaching shown in FIGS. 3 to 5,

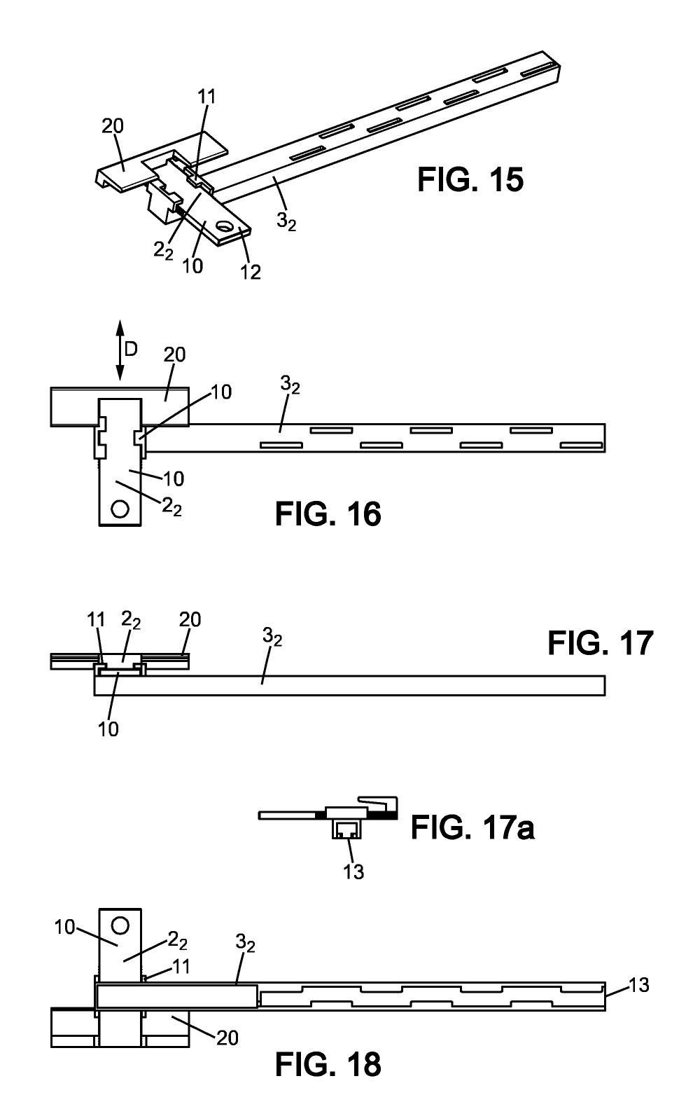

FIGS. 15, 16, 17, 17a and 18 are respectively perspective, top, front, side and bottom views of a device for attaching in accordance with the invention, according to a second embodiment,

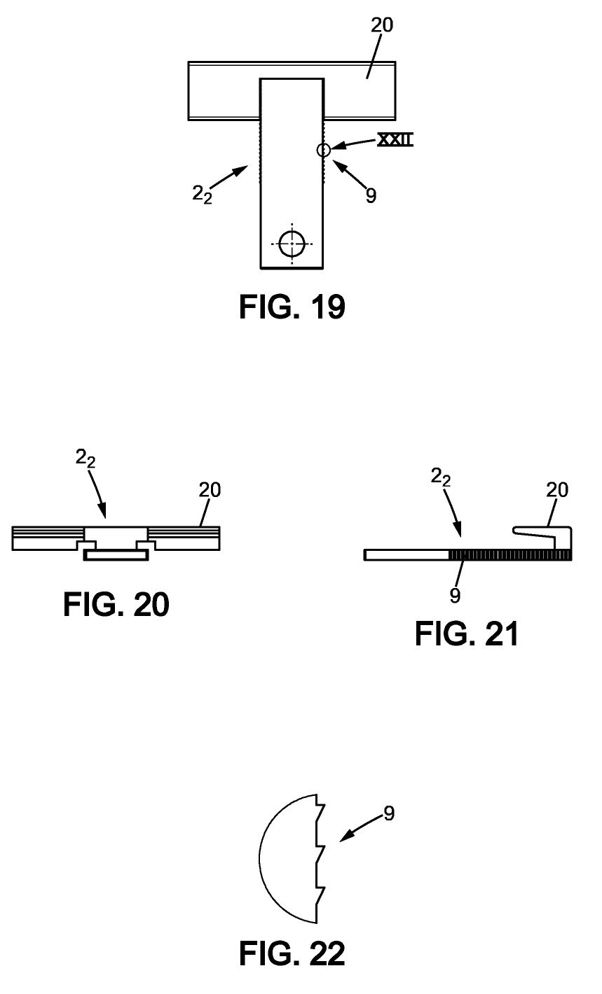

FIGS. 19, 20, 21 and 22 are respectively top, front, side and detailed views (according to the frame XXII-XXII) of the mobile retaining element of the device for attaching shown in FIGS. 15 to 18,

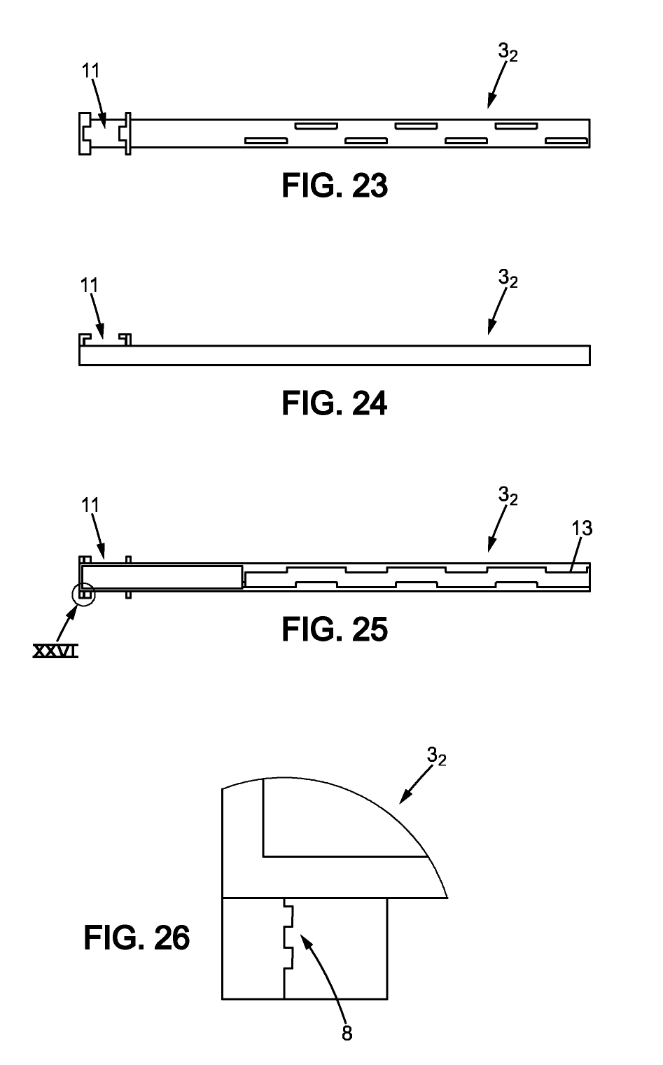

FIGS. 23, 24, 25 and 26 are respectively top, front, bottom and detailed views (according to the frame XXVI-XXVI) of the fixed support of the device for attaching shown in FIGS. 15 to 18,

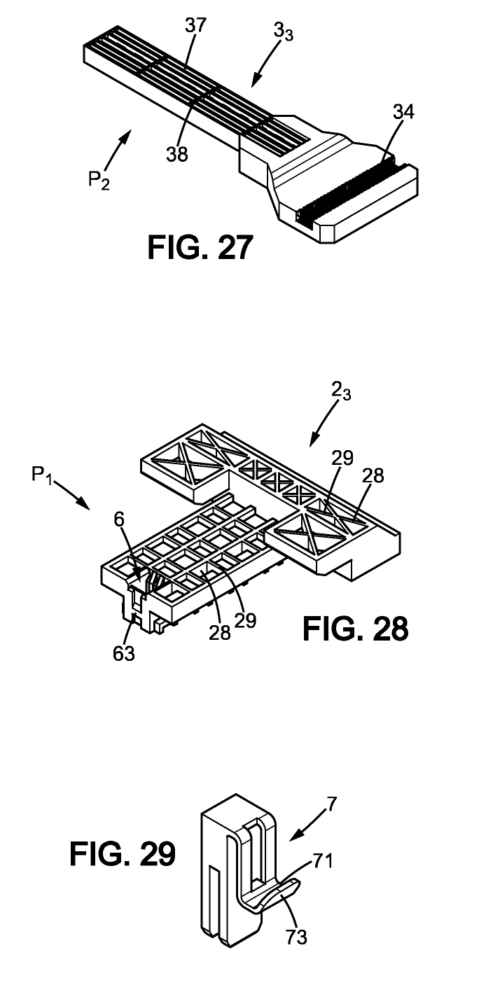

FIGS. 27, 28 and 29 are respectively perspective views of the various elements comprising an assembly of a device in accordance with the invention, according to a third embodiment, and more particularly views of the fixed support, of the mobile retaining element, and of a locking member,

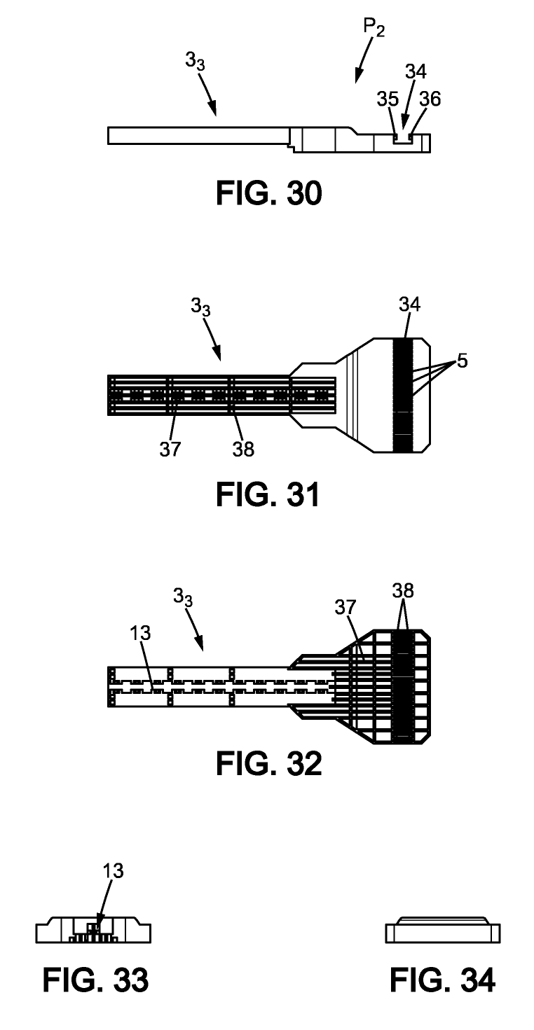

FIGS. 30 to 34 are respectively front, bottom, top side (left) and side (right) views of the fixed support shown in FIG. 27,

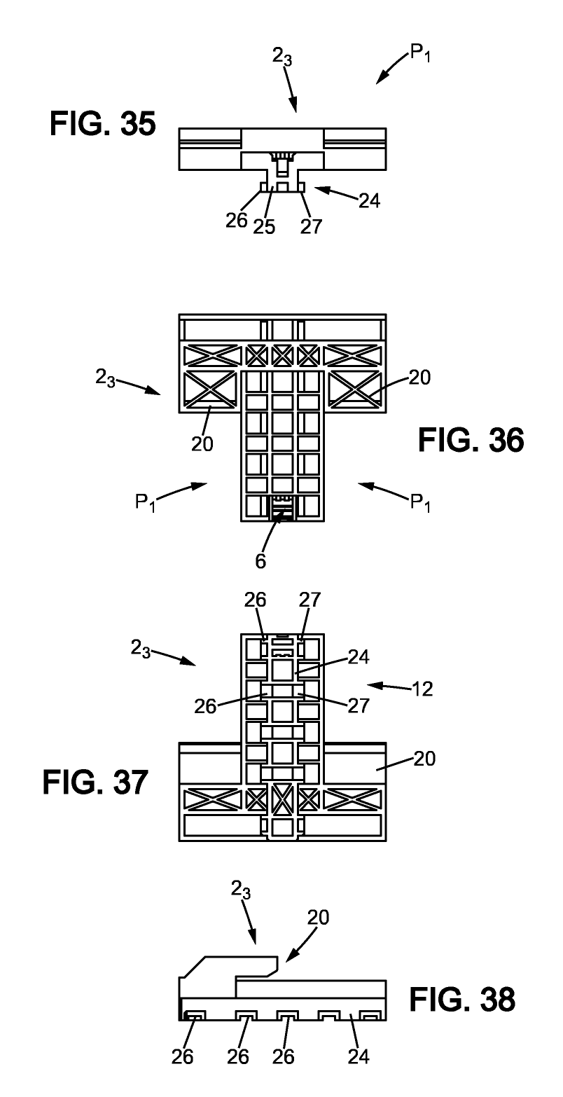

FIGS. 35 to 38 are respectively front, top, bottom, and side views of the mobile retaining element shown in FIG. 28,

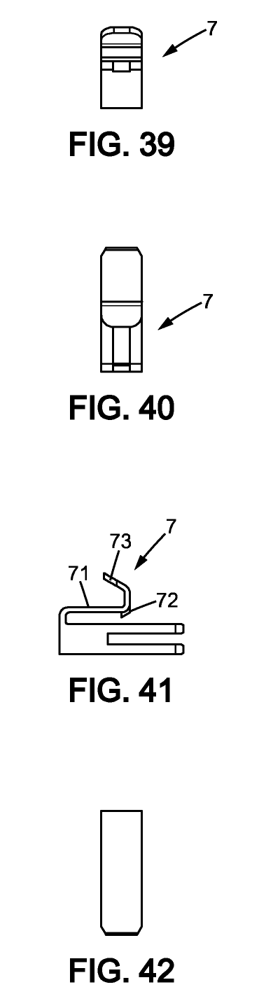

FIGS. 39 to 42 are respectively top, front, side and rear views of the locking member shown in FIG. 29,

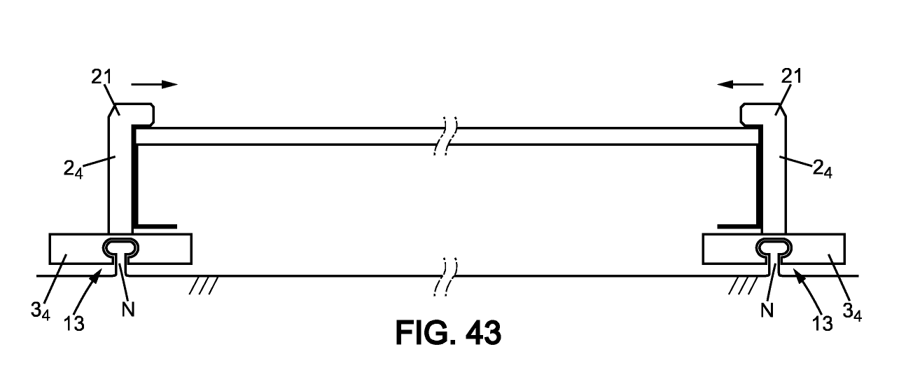

FIG. 43 is a diagrammatical view of a device for attaching, according to yet another embodiment, comprising two mobile retaining elements that provide the attaching of the solar panel via its frame, via the outside,

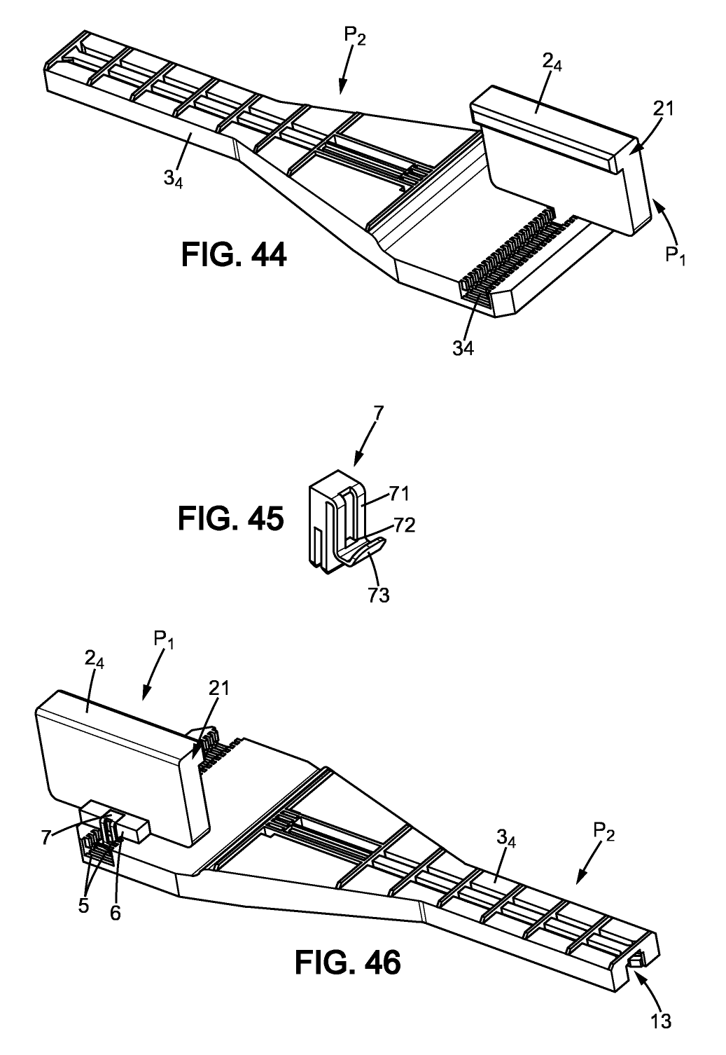

FIG. 44 shows a device in accordance with the invention according to a fourth embodiment, which makes it possible to provide the retaining of the frame by the outside and such as shown diagrammatically in FIG. 43,

FIG. 45 is a view of the locking member used to block the position of the retaining element with respect to the fixed support of the device of FIG. 44,

FIG. 46 is a view of the assembly shown in FIG. 45, in the locked position of the retaining element,

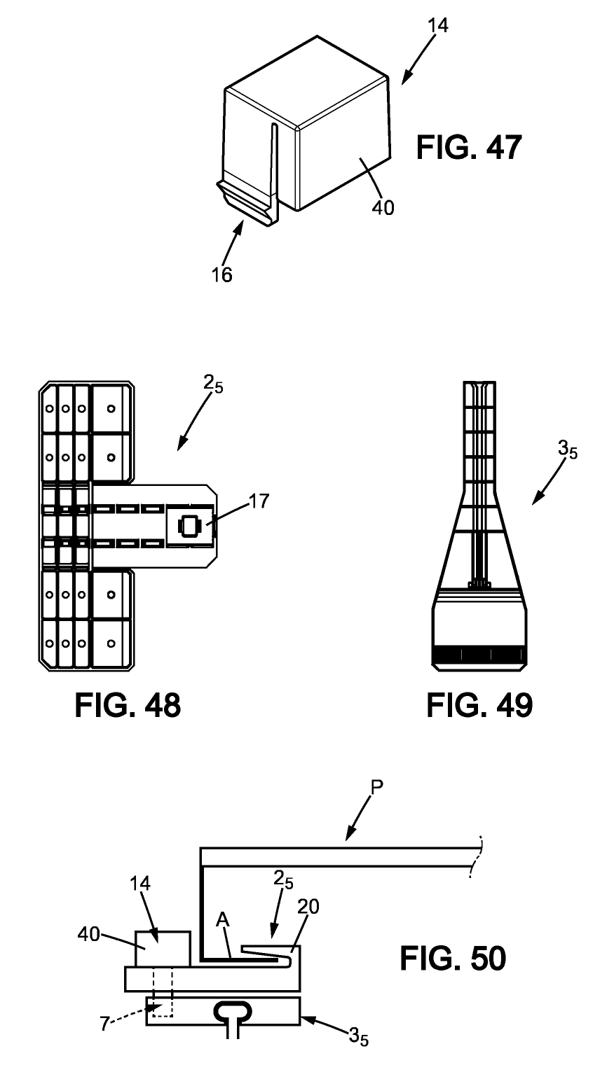

FIGS. 47, 48, 49 are respectively views of an abutment system, of a retaining element and of a corresponding fixed support, of a device in accordance with a fifth embodiment,

FIG. 50 is a diagrammatical view of the retaining of a portion of the solar panel, the hook of the retaining element of FIG. 48 engaging with the lower flange of the frame, inside the solar panel, said abutment system in FIG. 47 being integral with the retaining element, forming an external abutment that prohibits the unhooking of the frame,

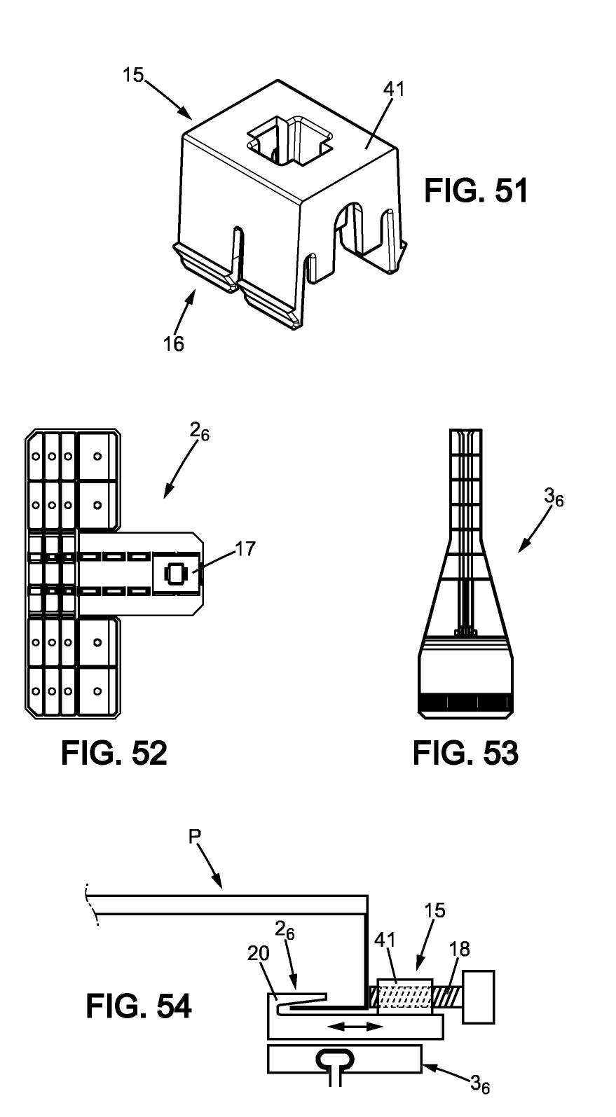

FIGS. 51, 52, 53 are respectively views of an abutment system with a screw (partial view without the screw), of a retaining element and of a fixed support, of a device in accordance with a sixth embodiment,

FIG. 54 is a diagrammatical view of the retaining of a portion of the solar panel, the hook of the retaining element of FIG. 52 engaging with the lower flange of the frame, inside the solar panel, said abutment system in FIG. 51 being integral with the retaining element, forming an external abutment that prohibits the unhooking of the frame, with the screw providing the hooking without play of the frame by the hook,

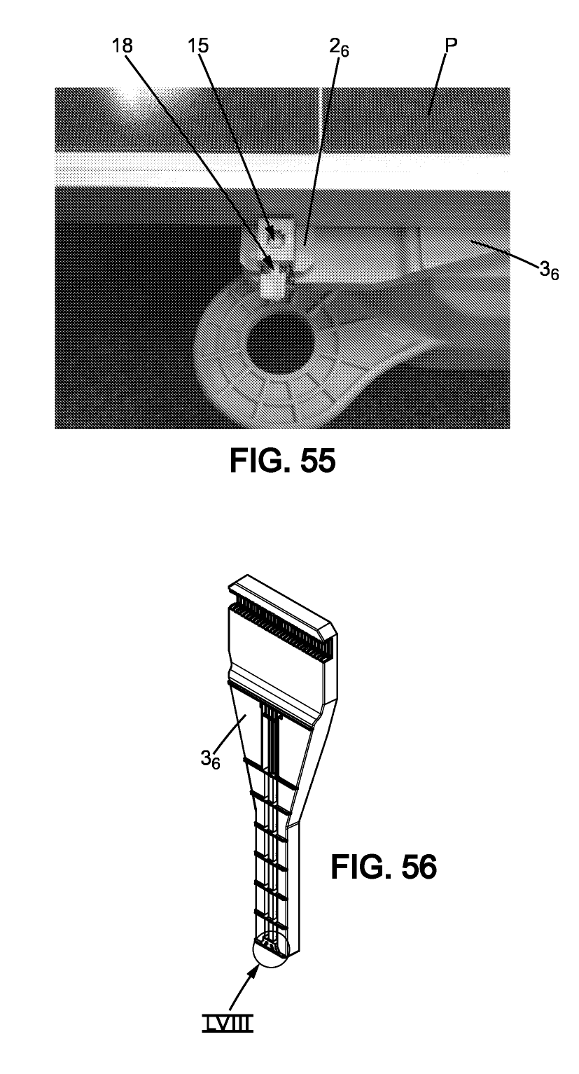

FIG. 55 is a photograph of a mounting of the type of that shown diagrammatically in FIG. 54,

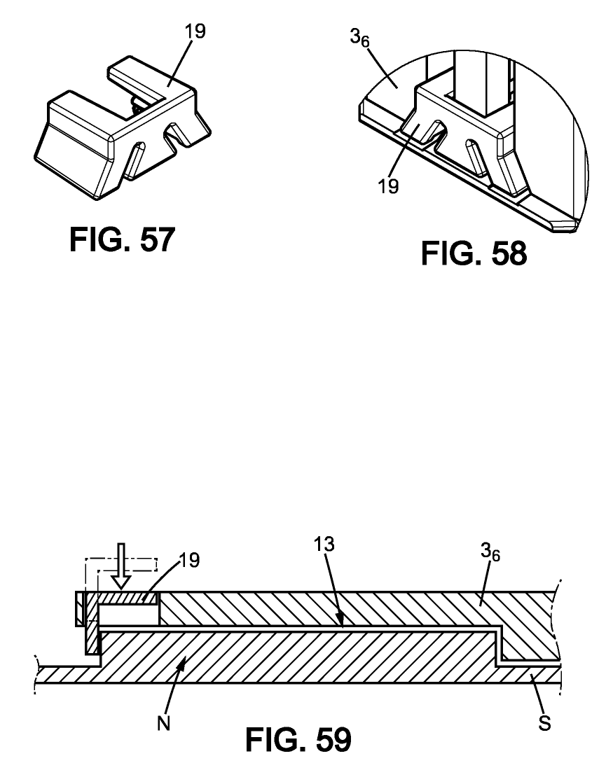

FIGS. 56 and 57 are respectively views of a said fixed support provided with a fitting groove and with a removable blocking member, which can be inserted into an upper opening of said fixed support,

FIG. 58 is a partial view of said fixed support, when said blocking member is snap-fit into the upper opening of said fixed support,

FIG. 59 is a diagrammatical cross-section view of a support element secured to a support, by insertion of a rib of the support along the fitting groove, and showing said blocking member, snap-fit to said support element, in a position wherein said blocking member forms an abutment for an end of the attaching rib, prohibiting the withdrawal thereof out of the fitting groove,

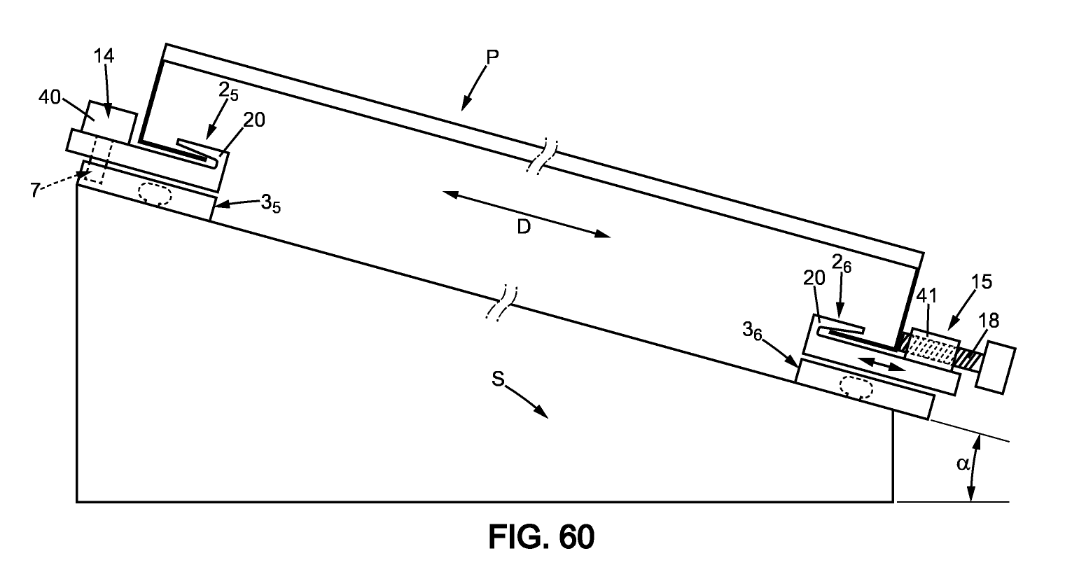

FIG. 60 is a diagrammatical view of an assembly comprising a solar panel and a device for attaching according to the invention, integral with a support that inclines the solar panel by an angle a, said device for attaching comprising at least two retaining elements fastening said panel by engaging with two opposing parts of the solar panel, said upper retaining element being locked to its fixed support for example by the insertion of one said locking member, said lower retaining element being voluntarily left mobile with respect to the fixed support thereof in such a way as to authorise the sliding of said mobile retaining element along said corresponding fixed support, in particular so as to take into account any heterogeneous expansions between the solar panel and the support whereon the two retaining elements are fixed.

Also the invention relates to a device for attaching 1 a solar panel comprising at least two retaining elements 2, 2′ suitable for retaining a panel by engaging with two opposing parts of the solar panel, at least one of the retaining elements 2, 2′ being movable in a direction D defined by a guide system and in such a way as to allow an adjustment of the spacing between the two retaining elements 2, 2′.

Such a device for attaching is shown diagrammatically in FIG. 1, by way of a non-limiting example. Generally, one and even the two retaining elements 2, 2′ are mobiles in the direction D, allowing as such for the adjusting of the spacing between the retaining elements 2, 2′ to the desired mounting dimension.

According to this embodiment, the two retaining elements each have hooks 20, turned outwards and in such a way as to engage, respectively with two lower flanges of the frame. These two lower flanges A extend typically towards one another, in a way that is substantially parallel to the solar panel P. In this case, the hooks of the retaining elements provide the taking of the frame from the inside, when the retaining elements are displaced, and separated from one another.

According to an embodiment, shown in FIG. 43, the retaining elements can alternatively provide the taking of the panel, and even of its frame, by the outside.

The hooks 21 of the retaining elements are then turned inwards and in such a way as to engage with the panel, by the exterior. In this case, the hooks provide the taking of the panel from the outside, when the retaining elements are displaced, brought closer to one another.

According to the invention, the device has at least one assembly comprising a fixed support 3, 3′; 3₁, 3₂, 3₃, 3₄, 3₅, 3₆ and said mobile retaining element 2, 2′, 2₁, ²₂, 2₃, 2₄, 2₅, 2₆ said mobile retaining element 2, 2′, 2₁, 2₂, 2₃, 2₄, 2₅, 2₆ and said fixed support 3, 3′; 3₁, 3₂, 3₃, 3₄, 3₅, 3₆ consisting respectively of two plastic synthetic parts P1, P2, the guide system being produced by mutually engaging structures between said mobile retaining element 2, 2′, 2₁, 2₂, 2₃, 2₄, 2₅, 2₆ and said fixed support 3, ³′; ³₁, 3₂, 3₃, 3₄, 3₅, 3₆ produced as a one-piece component with said parts P1, P2 forming said fixed support and said mobile retaining element.

In FIG. 1, and according to an embodiment, the device for attaching 1 has as such, a first assembly (on the left) comprising said mobile retaining element 2 and said fixed support 3, as well as a second assembly (on the right) comprising said mobile retaining element 2′ and said fixed support 3′.

The adjusting system according to the invention, extends more preferably, locally over a portion of width of the solar panel, and not over the entire width of the solar panel, such as known in prior art with metal rails. The fixed support 3; 3′ is a synthetic part, in particular a plastic part intended to be fastened securely to a mounting support S.

According to another embodiment not shown, the device for attaching can have a single mobile retaining element, intended to engage on one side of the panel, with the other being fixed.

Advantageously, and according to the invention, said mobile retaining element 2, 2′ and said support 3; 3′ (including the structures of the guide system between these two elements) are formed by two plastic parts P1, P2 which can be manufactured at least cost, for example by the techniques of injection moulding.

Details shall be provided in the description of six possible embodiments (not limiting), with:

a first embodiment of a mobile retaining element 2₁/fixed support 3₁ assembly shown in FIGS. 2 to 14,

a second embodiment of a mobile retaining element 2₂/fixed support 3₂ assembly, shown in FIGS. 15 to 26 and,

a third embodiment of a mobile retaining element 2₃/fixed support 3₃ assembly, shown in FIGS. 27 to 42,

a fourth embodiment of a mobile retaining element 2₄/ fixed support 3₄ assembly, shown in FIGS. 43 to 46.

a fifth embodiment of a mobile retaining element 2₅/ fixed support 3₅ assembly, shown in FIGS. 47 to 50.

a sixth embodiment of a mobile retaining element 2₆/ fixed support 3₆ assembly, shown in FIGS. 51 to 56.

According to an embodiment, said mobile retaining element 2, 2′; 2₁; 2₂; 2₃; 2₅; 2₆; can comprise a hook 20 intended to engage with a flange A of the frame, the hook being preferably directed outwards and in such a way as to engage with a lower flange of the frame (see FIG. 2).

This hook 20 is preferably of a one-piece component with said part P1, forming said mobile retaining element and can as such be obtained during the moulding of the part P1.

As such and according to an embodiment, the mobile retaining element 2, 2′, 2₁, 2₂, 2₃, 2₅, 2₆ comprises a hook 20 intended to engage with a flange A of the frame, said hook being a one-piece component with said part forming said mobile retaining element.

The hook 20 can advantageously comprise a converging inner structure and in such a way as to provoke a clamping of the flange A of the frame, when the hook 20 of the mobile retaining element is displaced in the direction of the flange of the frame. According to another alternative, shown in FIGS. 43 to 46, the retaining element 2₄ can comprise a hook 21, directed inwards and intended to engage with the panel, even with its frame via the exterior. To this effect, the hook 21, preferably a one-piece component with the part forming the retaining element 2₄.

According to an embodiment, the guide system between the mobile retaining element 2₁ and the fixed support 3₁ comprises a longitudinal opening 32 passing through the body of the fixed support 3₁ oriented in the adjusting direction D, as well as a protruding portion 22, in particular cylindrical, of said body of said mobile retaining element 2₁, passing through said longitudinal opening and guided by said longitudinal opening 32.

The longitudinal opening 32, in particular of oblong shape, as such allows for the guiding of the protruding portion 22 over the entire length thereof, oriented according to the adjusting direction D.

The body of the retaining element 2₁, of a larger dimension bears on and slides over an upper surface of the body of the fixed support. Said protruding portion is terminated in the lower portion by an enlarged end 23, intended to engage in abutment with the underside of the body of said fixed support 3.

Said enlarged end 23 can be oriented, lengthwise, substantially orthogonally to said axis of said protruding portion 22. The enlarged end 23 forms with said protruding portion 22 a structure with an inverted T shape (see in particular FIG. 7).

The enlarged end 23 is with a width less than the width of the longitudinal opening 32 of said fixed support, at least locally on the longitudinal opening 32, and of a length greater than the width of said longitudinal opening 32, and in such a way as to allow for the assembly of the fixed support 3₁ with said mobile retaining element 2₁ by the following steps:

insertion of the enlarged end 23 of the mobile retaining element 2₁, oriented along the axis of the longitudinal opening 32, through the longitudinal opening of the support element 3₁.

rotation of the mobile retaining element 2₁ with respect to the fixed support 3₁ along the axis of the protruding portion 22, in particular by a quarter turn, and in such a way as to provide the assembly of the two parts.

The assemblage between the two parts P1 and P2 is as such carried out easily and without any added part. According to an embodiment, the insertion of the protruding portion 22 and of the enlarged end 23 thereof can be done only on a local zone of the longitudinal opening 32. For example in FIG. 23, note that this insertion is only possible on a median zone of the longitudinal opening 32, having an indentation 33, and not over the entire length of the longitudinal opening 32, as such preventing an untimely disassembly between the two parts P1, P2.

The assembly of the device according to the invention has a system for locking the position of the mobile retaining element 2₁; 2₂; 2₃; 2₄; 2₅; 2₆ with respect to said fixed support 3₁; 3₂; 3₃; 3₄; 3₅; 3₆.

This system for locking allows for a locking of position, in several discrete adjusting positions. Advantageously, said system for locking comprises at least partially structures of said mobile retaining element 2₁; 2₂; 2₃; 2₄, 2₅; 2₆ and of said fixed support 3₁; 3₂; 3₃; 3₄, 3₅; 3₆ distributed in the direction D of said guide system, produced as a one-piece component with said parts P1, P2 forming said fixed support and said mobile retaining element.

Here again the structures of the system for locking are preferably advantageously obtained at least partially during the moulding of the synthetic parts P1, P2 in particular plastic parts. Possibly, all of the parts of the system for locking are obtained during the moulding of the two synthetic parts P1, P2.

According to an embodiment, the structures of said system for locking comprise a plurality of adjusting openings 5 of said fixed support 3₁ or 3₃ or 3₄ or 3₅ or 3₆ distributed, more preferably regularly spaced, along the adjusting direction D, as well as at least one corresponding opening 6 of said mobile retaining element 2₁ or 2₃ or 2₄ or 2₅ or 2₆ intended to be placed facing with one of the openings 5 of said fixed support which is best suited for adjusting. A locking member 7, such as a pin is then intended to pass through said facing openings in order to ensure the locking of the position.

Such an embodiment is shown by way of a non-limiting example in FIGS. 3 to 14 according to a first embodiment. The adjusting openings marked 5 of said fixed support are made along the longitudinal opening 32, with each opening 5 made by means of two indentations extending on either side of the opening 32, widthwise. The mobile retaining element 2₁ has several openings 6, in particular with a rectangular section. The relative position between the mobile retaining element 2₁ and the fixed support 3₁, is locked by inserting a locking member 7 with a pin function through two openings 5, 6 placed facing.

In the case where the mobile retaining element 2₁ has a single opening 6, the different adjusting positions are defined by the spacing between the openings 5 of said fixed support. The minimum separation between two adjacent adjusting positions corresponds to this spacing. Advantageously the adjusting fineness can be increased by providing at least two corresponding openings 6 on the fixed support 3₁, such as for example three openings 6 according to FIG. 6. The spacing between the openings 6 of the fixed support 3₁ is separate from the spacing of the openings 5 of the mobile retaining element 2₁, and without being a multiple of the latter. As such and when one of the openings 6 of said mobile retaining element 2₁ is facing a corresponding opening 5 of the fixed support 3₁, the opening or openings 6 are in intermediate positions (not facing).

Said locking member 7 can be formed as a scored portion of the part P1 forming the body of said mobile retaining element 2₁ or the part forming said fixed support. Therefore and such as shown in FIG. 6, the locking member 7 is adjoining to the body of the mobile retaining element 2₁ by a scored portion of the part P1. It is as such possible to carry out the system for locking entirely during the manufacturing of two synthetic parts P1, P2, in particular during the injection moulding of the part P1. Another advantage is that the risks of losing this locking member 7 are limited.

The locking member 7 is a plastic part intended to simultaneously pass through an opening 6 in the body of said retaining element 2₃, as well as one of the openings 5 that is most suited to the adjusting of said fixed support 3₃. According to a non-limiting embodiment shown in FIGS. 27 to 42 or in FIGS. 43 to 46, the retaining in position of the locking member 7 in the opening 6 can be provided by a system of the snap-fit type of which the mutually engaging parts are distributed between the part P1 forming the retaining element 2₃ or 2₄ and the locking member 7. As such and according to the non-limiting example in FIG. 29, the body of the locking member 7 can have a deformable elastic flange 71, bearing a tooth 72. When the locking member 7 is inserted through the opening 6 of said retaining element 2₃ or 2₄, the elastic flange 71 comes into contact with the part P1 and is deformed by separating the body from the member 7, until the tooth 72 passes and escapes from a relief 63 of the body of the retaining element 2₃ or 2₄. Once passed, the tooth 72 attaches the relief 63, prohibiting the withdrawal of the member 7 in the reverse direction. The withdrawal of the locking member 7 can be however possible, without tools, via a manual action on a grasping end 73 of the elastic flange 71, and in such a way as to clear the tooth 72 in a position where it no longer interferes with the blocking. According to this particular example and generally, this can as such be a snap-fitting system of the reversible type.

According to another embodiment, shown in a non-limiting manner in FIGS. 15 to 26, the structures of said system for locking can include toothings 8, 9 distributed between said mobile retaining element 2₂ and said fixed support 3₂, with an anti-reverse function. Advantageously these toothings 8, 9 mutually engage in such a way as to authorise a displacement according to a first direction, in the adjusting direction D, between said mobile retaining element 2₂ and said fixed support 3₂, with the toothing prohibiting the reverse direction of displacement.

According to an embodiment, the mutually engaging structures 10, 11; 24, 34 of said guide system between said retaining element 2₂; 2₃ and said fixed support 3₂; 3₃ form a sliding connection between the two parts P1, P2.

For example and according to an embodiment, the structures of said guide system comprise a blade 10 of said mobile retaining element 2₂, as well as a slide 11 of said fixed support 3₂, inside of which said blade 10 is threaded and guided.

Such a guide and locking system and is shown as a non-limiting example in FIGS. 15 to 26. According to this example, the blade extends from the hook 20 and is terminated by a free end. The slide is formed by edges engaging with the two longitudinal edges of the blade.

The toothing 9 formed on the mobile retaining element 2₂ is carried out along the two longitudinal edges of the blade: this is toothing of which the teeth have a triangle shape. These teeth 9 are intended to engage with a toothing 8 carried out along the inside edges of the slide 11, with a rectangular tooth base. The triangle profile of the toothing 8 authorises the displacement of the retaining element 2₁ with respect to the fixed support 3₁ in a single direction, in particular when the blade is pulled, but prohibits any reverse movement. Here again such an embodiment makes it possible to carry out a position adjustment, advantageously without tools.

According to another embodiment shown in FIGS. 27 to 42 (or FIGS. 43 to 46), the mutually engaging structures forming the sliding connection of said guide system comprise a protruding portion 24 under the body of the part P1 forming said retaining element 2₃ (or 2₄ or 2₅ or 2₆), and a complementary groove 34, oriented along the part P2 forming said fixed support 3₃ (or 3₄ or 3₅ or 3₆) in depth on the upper face of the fixed support. The term complementary groove means the fact that the shape of the groove is complementary with the protruding portion in such a way as to prohibit the withdrawal thereof by displacement of the part in the direction of the entrance of the groove 34.

Generally, and as can be understood in the figures, the underside of the body of the part P and the upper face of the part P2 slide over one another, providing the uptake for the load.

As such the assembly between the two elements 2₃, 3₃ is provided by threading the protruding portion 24 into the complementary groove 34, by displacement according to the axis of the groove 34.

Such as shown as an example in FIG. 35, the protruding portion 24 can comprise a longitudinal rib 25 and a plurality of studs 26, 27 extending laterally, on either side of the rib. This protruding portion 24, with a section with a generally inverted T shape, is intended to be threaded into the groove 34, of complementary shape, with this groove 34 comprising edges 35, 36 intended to engage with said studs 26, 27 in order to provide a blocking in a direction perpendicular to the axis of the slide, and as such prohibit withdrawal via the groove entrance.

According to an advantageous embodiment, said mobile retaining element 2₁; 2₂; 2₃, 2₅, 2₆ comprises an engagement portion such that said hook 20 intended to engage with the frame of the solar panel P when the two retaining elements 2, 2′ are separated, as well as a protruding portion of said engagement portion in the form of a pull tab 12 or equivalent, for the grasping, intended to extend substantially parallel to the solar panel P, outwards from said solar panel, and in such a way as to exit outwards.

The function of this pull tab 12 can be understood in the diagram of FIG. 2; this is a grasping portion of the mobile retaining element 2₁, 2₂ intended to be manipulated during the adjusting in order to move forward and even reverse (if possible) the mobile retaining element according to the direction D. Advantageously, the length thereof is such that this grasping part exits laterally under the panel P, and as such is easy for the operator to access from the outside, and while the engagement portion, in particular the hook 20 is positioned under the panel P.

According to an embodiment, in particular visible according to the various examples shown, said fixed support 3₁; 3₂; 3₃; 3₄; 3₅; 3₆ comprises a fitting groove 13, located underneath the body of said fixed support 3₁; 3₂; ³₃; ³₄; 3₅; 3₆ open downwards. This groove is oriented lengthwise according to a direction orthogonal to the adjusting direction (D) and able to allow for the attaching of said fixed support 3₁; 3₂; 3₃; 3₄; 3₅; 3₆ to a complementary rib N intended to be threaded into said fitting groove 13.

The function of this fitting groove 13 is to allow for the attaching of the fixed support 3₁; 3₂; 3₃ of the assembly, rapidly and without tools, by threading the fitting groove 13 on a complementary rib N of a mounting support for example with a T-shaped section. Here again this fitting groove 13 can be obtained during the moulding of the part P2 that constitutes the fixed support 3₁; 3₂; 3₃; 3₄; 3₅; 3₆.

The attaching of the fixed support 3₁; 3₂; 3₃; 3₄; 3₅; 3₆ on a support S is as such obtained simply by threading a rib N of the support S into the fitting groove 13, according to the axis of the groove 13 and in particular until the rib N abuts on the end of the groove 13, not open.

Advantageously, the device can be provided with a blocking member 19, intended to be inserted, through an upper opening of said fixed support 3₅; 3₆, once the rib N threaded into the fitting groove 13, and in such a way as to form a physical abutment for an end of the attaching rib N. This blocking member 19 as such prohibits the withdrawal of the rib, and as such the dismounting of the fixed support, on the end of the groove entrance 13.

The blocking member 19 can be a plastic part, for example obtained by injection moulding, with the retaining of the blocking member 19 in the opening of said fixed support 3₅; 3₆ being provided thanks to means of snap-fitting distributed between said blocking member 19 and said fixed support 3₅; 3₆. An embodiment of such a blocking member is shown by way of example in FIGS. 56 to 59.

Advantageously, said mobile retaining element 2₁; 2₂, 2₃; 2₄; 2₅; 2₆ as well as said fixed support 3₁; 3₂; 3₃; 3₄; 3₅; 3₆ can be obtained respectively, by injection moulding of a synthetic material, in particular a plastic material, with the structures of the guide system, where applicable the structures of the system for locking, and even the fitting groove 13 and/or hook 20; 21, being obtained during the moulding of the two plastic parts P1, P2.

As shown in FIGS. 27 to 42, said plastic P1 forming said mobile retaining element 2₃, 2₅, 2₆ and/or the plastic part P2 forming said fixed support 3₃, 3₅, 3₆ can have a reinforcing rib. This reinforcing rib can comprise ribs at least according to two separate directions. As such the plastic part P1 forming said part P1 can have reinforcing grooves 28, 29, according to at least two different directions, and the part P2 can have reinforcing grooves 37, 38 according to two different directions.

This rib makes it possible to reinforce the plastic parts P1 and P2, while still retaining a low wall thickness for example between 1 m and 3 mm, compatible with a manufacture by injection moulding, and with manufacturing cycle times of a short duration.

According to an embodiment, shown by way of a non-limiting example in FIGS. 47 to 50, or in FIGS. 51 to 55 the device can comprise an abutment system 14; 15, removable attached to said retaining element 2₅; 2₆, able to prohibit the withdrawal of the lower flange A of the frame of the solar panel, by the creation of an abutment, with the frame of the panel taken, imprisoned between the hook 20, internal to the frame of the solar panel P, and the abutment system 14, 15, external to said frame of the solar panel.

During the installation, a first step is carried out of the hooking of the lower flange A of the solar panel P by the hook 20 of said retaining element 2₅; 2₆, then, in a second step, in the setting up of the abutment system 14; 15, for example via the snap-fitting on the upper surface of said retaining element. Inversely, and during dismounting, it is necessary to withdraw beforehand the abutment system 14; 15 in order to authorise the displacement of the frame in the direction D and according to a travel required for the unhooking.

The abutment system 14 can be comprised substantially of a plastic element 21, and means of snap-fitting 16, 17, more preferably reversible, distributed between said plastic element 40 and said retaining element 2₅, and as shown by way of example in FIGS. 47 to 50. The setting up of the abutment system 14 is obtained simply by snap-fitting of the plastic element 20 on the upper surface of said retaining element 2₅. The frame of the panel is as such imprisoned between the hook 20, internal to the frame of the solar panel P, and the abutment system 14, 15, external to said frame of the solar panel. Such an abutment system does not however make it possible to entirely suppress the mounting play.

According to an advantageous embodiment, the abutment system 15 can comprise, said plastic element 41, as well as a screw 18, engaging in the screwing with the plastic element, with the screwing of the screw 18 authorising the suppression of the mounting play of the frame of the solar panel taken, on the one hand, interiorly by the hook 20 engaging with the lower flange A of the frame, and the abutment system 15 of which the screw 18 bears without play on the outside on the frame of the solar panel P. Such an embodiment is shown in FIGS. 51 to 54. According to this embodiment, the setting up of the abutment system is obtained by snap-fitting of the plastic element onto the upper surface of said retaining element 2₆. The screwing of the screw 18, allows for the displacement thereof to the hook 20, and until contact is made with the frame of the solar panel. This screw makes it possible to suppress the mounting play, along the axis of the screw. Typically the axis of the screw 18 is substantially parallel to the adjusting direction D. The tightening of the screw can again make it possible, advantageously, to block the solar panel P in the direction parallel to the panel and perpendicular to the adjusting direction D, thanks to the friction created as such. The screw can be plastic and have a wide head so as to allow for the screwing/unscrewing without a tool (without a screwdriver).

These two abutment systems marked 14 and 15 (simple or with a screw) can be combined in order to retain a solar panel, and as shown as an example in FIG. 60. Generally, the plastic element 40 or 41 can be obtained by injection moulding.

Such a mobile retaining element/fixed support assembly, has the following advantages:

it can be manufactured at least cost, and in large quantities, via the techniques of injection moulding,

it facilitates the installation of a solar panel, in that, in particular,

the fastening of the assembly to a mounting support can be carried out without a tool, in particular thanks to the fitting groove 13,

the grasping parts (i.e. draw bars 12) can be accessed easily by the operator, facilitating the position adjusting by the operator,

the locking of the desired adjusting position can be carried out easily, and in particular without tools.

Such a device will have particular application for the attaching of a solar panel, in particular on a roof or on floating modules of a solar power station on water.

The invention further relates to an assembly comprising a solar panel P retained by a device for attaching 1 a solar panel according to the invention, said device for attaching 1 comprising at least two retaining elements, providing the retaining of said panel integral by engaging with two opposing parts of the solar panel, at least one of the retaining elements being movable in a direction D defined by a guide system and in such a way as to allow an adjustment of the spacing between the two retaining elements.

Said assembly comprises said fixed support 3, ^{3;} 3₁; 3₂; 3₃; 3₄; 3₅; 3₆ and said mobile retaining element 2, 2′; 2₁; 2₂; 2₃, 2₄; 2₅, said mobile retaining element 2, 2′; 2₁, 2₂, 2₃; 2₄; 2₅; 2₆, and said fixed support 3, 3; 3₁; 3₂; 3₃; 3₄; 3₅ consisting respectively of two synthetic parts P1, P2, the guide system being produced by mutually engaging structures between said mobile retaining element 2, 2′, 2₁; 2₂; 2₃; 2₄; 2₅; 2₆, and said fixed support 3, ^{3;} 3₁; 3₂; ³₃; ³₄; 3₅; 3₆ produced as a one-piece component with said parts P1, P2 forming said fixed support and said mobile retaining element.

According to an advantageous embodiment, one 2₅ of the at least two retaining elements provides the retaining of said solar panel P, at one of the two opposing parts of the solar panel, in a fixed position with respect to the support S whereon are fixed the two retaining elements 2₅, 2₆ and the possible fixed support 3₅, 3₆ thereof, while the other retaining element 2₆ providing the retaining by engaging with the other opposing part of the panel, is voluntarily left mobile with respect to said corresponding fixed support 3₆, in the direction D.

Leaving said retaining element 2₆ mobile authorises the sliding of said mobile retaining element 2₆ along said corresponding fixed support 3₆, in the case of heterogeneous expansions between the solar panel P and the support S whereon are fixed the two retaining elements 25, 26 and their possible fixed support 35, 36. Advantageously, the appearance of mechanical stresses on the panel linked to the expansions of the support S or of the solar panel is avoided.

Such an embodiment is shown by way of a non-limiting example in FIG. 60.

According to such an embodiment, the solar panel is retained at one of the two opposing parts of the panel (on the left in FIG. 60) by the assembly comprising said fixed support 3₅, and said retaining element 2₅ of which the relative position is locked, in the adequate adjusting position, by the adding of a locking member 7 that passes through two openings facing these two elements 2₅, 3₅. In other words, said retaining element 2₅, once locked is in a fixed position with respect to the support S. The hook 20 of the retaining element 2₅ engages with the lower flange A of the frame of the solar panel P, inside the frame, with the frame being retained prisoner by the adding of the abutment system 14 (simple abutment).

The solar panel P is retained at the other opposing part of the solar panel P (for example on the right in FIG. 60) by the assembly comprising said fixed support 3₆, and said retaining element 2₆. Advantageously this retaining element 2₆ is voluntarily left mobile with respect to said corresponding fixed support 3₆, in the direction D. The sliding connection between the two elements 2₆, 3₆ as such allows said retaining element 2₆ to be displaced under the action of the phenomena of expansion that can be encountered for the solar panel P and/or the support S, with this possibility of adjusting making it possible to avoid the creating of a mechanical stress on the solar panel P that can deteriorate it.

According to an embodiment, the support S provides an inclination of the solar panel 20 in relation to the horizontal, for example by an angle a between 10° and 30°. Said retaining element 2₅ retaining the part of the solar panel, in the upper portion of the solar panel P in a fixed position is that of the device in accordance with the invention of which the hook 20 is turned outwards and in such a way as to engage with a lower flange A of the frame of the solar panel. As such and advantageously the force of gravity on the solar panel naturally forces the flange A of the frame to engage with the hook 20 of said retaining element, while said retaining element 2₆ left mobile in the direction D is located in the lower portion of the solar panel P.

The hook 20 of said retaining element 2₆ left mobile in sliding is, according to an embodiment, turned outwards in such a way as to hook the lower flange A of the frame, inside the frame. The abutment system 15 is fixed on said retaining element 2₆, outside the frame, and in such a way as to allow for a mounting without play. The abutment system comprises the plastic element 21 snap-fit onto the upper portion of said retaining element 2₆, as well as a screw 18 engaging in the screwing with said plastic element 21. The screwing of the screw 18 provokes the displacement of the end of the screw in the direction of the hook 20, and until the abutment of the screw against the peripheral lateral wall of the frame, and so as to obtain the suppression of the play, and even the blocking of the panel according to a direction perpendicular to the direction D and parallel to the panel, thanks to the friction created.

Naturally other embodiments can be considered by those skilled in the art without however leaving the scope of the invention such as defined hereinafter.

### NOMENCLATURE

1. Device for attaching,

2, 2′. Retaining elements (embodiment of FIG. 1),

3, 3′. Support fixe (embodiment of FIG. 1)

2₁, 3₁. Mobile retaining element/fixed support assembly (embodiment of FIGS. 2 to 14)

2₂, 3₂, Mobile retaining element/fixed support assembly (embodiment of FIGS. 15 to 26),

2₃, 3₃. Mobile retaining element/fixed support assembly (embodiment of FIGS. 27 to 42),

2₄, 3₄. Mobile retaining element/fixed support assembly (embodiment of FIGS. 43 to 46),

2₅, 3₅. Mobile retaining element/fixed support assembly, with a simple abutment system (embodiment of FIGS. 47 to 50),

2₆, 3₆. Mobile retaining element/fixed support assembly with abutment system with screw (embodiment of FIGS. 51 to 55),

20. Hook (retaining element),

21. Hook (retaining element marked 2₄),

22. Protruding portion (guide structure of the mobile element 2₁)

23. Enlarged end (Protruding portion),

24. Protruding portion (guide structure of the mobile element 2₃ or ²₄),

25. Rib (Protruding portion 24),

26, 27. Blocking studs (Protruding portion 24),

28, 29. Reinforcing ribs

32. Longitudinal opening (guide structure of the fixed element 30,

33. Indentation (longitudinal opening),

34. Groove (guide structure of the fixed element 3₃),

35, 36 Edges at the entrance of the groove (intended to engage with the studs),

37, 38. Reinforcing ribs

5. Adjusting openings (structures of the system for the locking of the fixed support 3₁, 3₃ or 3₄),

6. Openings (structures of the system for locking of the mobile retaining element 2ᵢ, 2₃ or 2₄),

7. Locking member such as a pin (system for locking).

8. Toothing (structures of the system for locking of the fixed support 3₂),

9. Toothing (structures of the system for locking of the mobile element 2₂),

10. Blade (guide structure of the mobile element 2₂),

11. Slide (guide structure of the fixed element 3₂),

12. Pull tab

13. Attaching groove

14. Abutment system (simple),

15. Abutment system (with screw),

16, 17. Means of snap-fitting, mutually engaging, between the plastic part of the abutment system and the plastic part of said retaining element,

18. Clamping screw (abutment system 15),

19. Blocking member (prohibiting the withdrawal of the rib outside of the fitting groove),

40. Plastic element (Abutment system 14),

41. Plastic element (Abutment system 15 with screw),

63. Relief (Snap-fitting system),

71. Elastic flange (Snap-fitting system on the locking member 7),

72. Dent (Snap-fitting system on the locking member 7)

73. Grasping end (Elastic flange 71).

A. Panel frame flange

D. Adjusting direction defined by the guide system,

N. Rib,

P. Solar panel,

P1, P2. Parts,

S. Mounting support

1. Device for attaching (1) a solar panel comprising at least two retaining elements (2, 2′), suitable for retaining a panel by engaging with two opposing parts of the solar panel, at least one of the retaining elements (2, 2′) being movable in a direction (D) defined by a guide system and in such a way as to allow an adjustment of the spacing between the two retaining elements (2, 2′), the device comprising:
an assembly comprising a fixed support (3, 3′; 3₁; 3₂; 3₃; 3₄; 3₅; 3₆) and said mobile retaining element (2, 2′; 2₁; 2₂; 2₃;
2₄; 2₅), said mobile retaining element (2, 2′; 2₁, 2₂; 2₃; 2₄;
2₅; 2₆), and said fixed support (3, 3′; 3₁; 3₂; 3₃; 3₄; 3₅, 3₆) consisting respectively of two synthetic parts (P1, P2), in particular plastic parts, the guide system being produced by mutually engaging structures between said mobile retaining element (2, 2′, 2₁; 2₂; 2₃; 2₄; 2₅; 2₆), and said fixed support (3, 3′; 3₁; 3₂; 3₃; 3₄; 3₅; 3₆) produced as a one-piece component with said parts (P1, P2) forming said fixed support and said mobile retaining element.

2. Device according to claim 1, comprising said mobile retaining element (2, 2′; 2₁; 2₂; 2₃; 2₄; 2₅; ²₆), comprises a hook (20; 21) intended to engage with the frame, said hook being a one-piece component with said part (P1) forming said mobile retaining element (2₁; 2₂; 2₃; 2₄; 2₅; 2₆).

3. Device according to claim 2, wherein the hook (20) has a converging inner structure and is arranged in such a way as to provoke a clamping of the flange (A) of the frame when the hook (20) of the mobile retaining element is displaced in the direction of the flange of the frame.

4. Device according to claim 2, wherein the hook (20) is turned outwards and in such a way as to engage with a lower flange (A) of the frame, when the two retaining elements engaging with the two opposing parts of the solar panel are separated from one another.

5. Device according to claim 4, comprising an abutment system (14; 15), removable attached to said retaining element (2₅; 2₆), able to prohibit the withdrawal of the lower flange (A) of the frame of the solar panel, by the creation of an abutment, with the frame of the panel taken, imprisoned between the hook (20), internal to the frame of the solar panel (P), and the abutment system (14, 15), external to said frame of the solar panel.

6. Device according to claim 5, wherein the abutment system (14; 15) comprises a plastic element (40; 41), and means for reversible snap-fitting (16, 17) distributed between said plastic element (20, 21) and said retaining element (2₅; 2₆).

7. Device according to claim 6, wherein the abutment system (15) comprises, said plastic element (41), as well as a screw (18), engaging in the screwing with the plastic element, with the screwing of the screw (18) authorising the suppression of the mounting play of the frame taken, on the one hand, interiorly by the hook (20) engaging with the lower flange (A) of the frame, and the abutment system of which the screw (18) bears without play on the outside on the frame of the solar panel (P).

8. Device according to claim 1, wherein the mutually engaging structures (10, 11; 24, 34) of said guide system between said retaining element (2₂; 2₃; ²₄, 2₅; 2₆) and said fixed support (3₂; 3₃; 3₄) form a sliding connection between the two synthetic parts (P1, P2).

9. Device according to claim 8, wherein the mutually engaging structures forming the sliding connection of said guide system comprise a protruding portion (24) under the body of the part (P1) forming said retaining element (2₃; ²₄), and a complementary groove (34) along the part (P2) forming said fixed support (3₃; 3₄).

10. Device according to claim 1, having a system for locking the position of the mobile retaining element (2₁; 2₂; 2₃; 2₄) with respect to said fixed support (3₁; 3₂; 3₃; ³₄), in several discrete adjusting positions, said system for locking comprising at least partially structures of said mobile retaining element (2₁; 2₂;
2₃; 2₄) and of said fixed support (3₁; 3₂; 3₃; 3₄) , distributed in the direction D of said guide system, produced as a one-piece component with said parts (P1, P2) forming said fixed support and said mobile retaining element.

11. Device according to claim 10, wherein the structures of said system for locking comprise a plurality of adjusting openings (5) of said fixed support (3₁; 3₃; 3₄), distributed, more preferably regularly spaced, according to the adjusting direction (D), as well as at least one corresponding opening (6) of said mobile retaining element (2₁; 2₃; 2₄) intended to be placed facing with one of the openings of said fixed support which is most suited to the adjusting, a locking member (7), such as a pin being intended to pass through said facing openings in order to ensure the locking of the position.

12. Device according to claim 11, comprising a snap-fitting system, preferably reversible, configured to ensure the retaining of the locking member (7) in the opening (6) of said retaining element (2₃; 2₄), of which the mutually engaging parts (63, 71, 72, 73) are distributed between the part (P1) of the retaining element (2₃) and the locking member (7)

13. Device according to claim 1, wherein said mobile retaining element (2₁; 2₂;
2₃) comprises an engagement portion such that said hook (20) intended to engage with the frame of the solar panel (P) when the two retaining elements (2, 2′) are separated, as well as a protruding portion of said engagement portion in the form of a pull tab (12) or equivalent, intended for the grasping, intended to extend substantially parallel to the solar panel (P), outwards of said solar panel, and in such a way as to exit outwards.

14. Device according to claim 1, wherein said fixed support (3₁; 3₂; 3₃; 3₄) comprises a fitting groove (13), located underneath the body of said fixed support (3₁; 3₂; 3₃; ³₄), open downwards, lengthwise according to a direction orthogonal to the adjusting direction (D) and able to allow for the attaching of said fixed support (3₁; 3₂; 3₃; 3₄; 3₅; 3₆), to a complementary rib (N) intended to be threaded into said fitting groove (13).

15. Device according to claim 14, provided with a blocking member (19), intended to be inserted, through an upper opening of said fixed support (3₅; 3₆) , once the rib (N) is threaded into the fitting groove (13), and in such a way as to form a physical abutment for an end of the attaching rib (N) and prohibit the withdrawal thereof.

16. Device according to claim 15, wherein the blocking member (19) is a plastic part, with the retaining of the blocking member (19) in the opening of said fixed support (3₅; 3₆) being provided thanks to means of snap-fitting distributed between said blocking member (19) and said fixed support (3₅; 3₆).

17. Device according to claim 1, comprising two independent assemblies (2, 3; 2′, 3′), each comprising a fixed support and said mobile retaining element, the mobile retaining elements of two assemblies being intended to engage with two opposing parts of said solar panel, in particular two parallel flanges of the frame of the solar panel.

18. Device according to claim 1, wherein said part (P1) forming said mobile retaining element (2₁; 2₂; _{23,} ^{24;} _{25;} 2₆) , as well as said part (P2) forming said fixed support (3₁, 3₂; 3₃; 3₄, 3₅; 3₆) are injection-moulded plastic parts.

19. Device according to claim 18, wherein the plastic part (P1) forming said mobile retaining element (2₃) and/or the plastic part (P2) forming said fixed support (3₃) have a reinforcing rib (28, 29; 37, 38).

20. Method for manufacturing a device according to claim 1, wherein said mobile retaining element (2₁; 2₂) is obtained, as well as said fixed support (3₁; 3₂) , respectively, by injection moulding of a synthetic material, the structures of the guide system, where applicable the structures of the system for locking being obtained during the moulding of the two plastic parts (P1, P2).

21. Assembly comprising a solar panel (P) retained by a device for attaching (1) a solar panel according to claim 1 comprising at least two retaining elements (2, 2′), retaining said panel by engaging with two opposing parts of the solar panel, at least one of the retaining elements (2, 2′) being movable in a direction (D) defined by a guide system and in such a way as to allow an adjustment of the spacing between the two retaining elements (2, 2′) said assembly comprising said fixed support (3, 3′; 3₁; 3₂; 3₃; 3₄; 3₅; 3₆) and said mobile retaining element (2, 2′; 2₁; 2₂; 2₃:2₄; 2₅), said mobile retaining element (2, 2′; 2₁, ²₂, 2₃; 2₄; 2₅; 2₆), and said fixed support (3, 3′; 3₁; 3₂; 3₃; 3₄; 3₅) consisting respectively of two synthetic parts (P1, P2), the guide system being produced by mutually engaging structures between said mobile retaining element (2, 2′, 2₁; 2₂; 2₃; 2₄; 2₅; 2₆), and said fixed support (3, 3′; 3₁; 3₂; 3₃; 3₄; 3₅; 3₆) produced as a one-piece component with said parts (P1, P2) forming said fixed support and said mobile retaining element.

22. Assembly according to claim 21, wherein one (2₅) of the at least two retaining elements provides the retaining of said solar panel (P), at one of the two opposing parts of the solar panel, in a fixed position with respect to the support (S) whereon are fixed the two retaining elements (2₅, 2₆) and the possible fixed support (3₅, 3₆) thereof, while the other retaining element (2₆) providing the retaining by engaging with the other opposing part of the panel, is left mobile with respect to said corresponding fixed support (3₆), in the direction (D), and in such a way as to authorise the sliding of said mobile retaining element (2₆) along said corresponding fixed support (3₆), in the case of heterogeneous expansions between the solar panel (P) and the support (S) whereon are fixed the two retaining elements (2₅, 2₆) and their fixed support (3₅, 3₆).

23. Assembly according to claim 22, wherein the support (S) providing an inclination of the solar panel (20) in relation to the horizontal, for example by an angle a between 10° and 30° , said retaining element (2₅) retaining the part of the solar panel, in the upper portion of the solar panel (P), in a fixed position with respect to the support (S), is that of the device wherein the mobile retaining element comprises a hook intended to engage with the frame, the hook being a one-piece component with the part forming the mobile retaining element,
the hook (20) being turned outwards and in such a way as to engage with a lower flange (A) of the frame of the solar panel when the two retaining elements engaging with the two opposing parts of the solar panel are separated from one another, with the force of gravity on the solar panel naturally retaining the flange (A) engaged with the hook (20) of said retaining element (25), while said retaining element (26) left mobile in the direction (D) is located in the lower portion of the solar panel.

24. A method for retaining a solar panel on floating modules, comprising providing the device of claim 1, and applying the device to the solar panel to retain said solar panel on the floating modules.
